(19) United States
(12) Patent Application Publication
(10) Pub. No.: US 2024/0372503 A1
(43) Pub. Date: Nov. 7, 2024

(54) Photovoltaic Tracking Support, Self-correcting Linkage Control Method and Readable Storage Medium

(71) Applicant: Mokun Renewable Technologies Co., Ltd., Shanghai (CN)

(72) Inventors: Jiabao Guo, Shanghai (CN); Xiao Liu, Shanghai (CN); Deqiang Pan, Shanghai (CN)

(21) Appl. No.: 18/654,924

(22) Filed: May 3, 2024

(30) Foreign Application Priority Data
May 5, 2023 (CN) 202310505635.6

(51) Int. Cl. H02S 20/30; G05D 3/12

(52) U.S. Cl. CPC H02S 20/30; G05D 3/12

(57) ABSTRACT

The present disclosure provides a photovoltaic tracking support, a self-correcting linkage control method and a readable storage medium, which relate to the field of photovoltaic power generation technology. A self-correcting device is disposed in the photovoltaic tracking support provided by examples of the present disclosure, and a controller in the self-correcting device performs linkage control of a plurality of drive devices according to the angle signal and rotational position signal at different length positions of the main beam. The photovoltaic tracking support uses mechanical and electrical structures for linkage control of the plurality of drive devices, effectively avoiding the problems caused by the use of drive rod for linkage, has a small maintenance workload, and helps to reduce costs.

### TECHNICAL FIELD

The present disclosure relates to the field of photovoltaic power generation technology, and in particular, to a photovoltaic tracking support, a self-correcting linkage control method, and a readable storage medium.

### BACKGROUND ART

In a photovoltaic power generation system, the flat single-axis tracking support is one of the commonly used forms of photovoltaic support. As the support is capable of tracking the azimuth changes of the sun, the light-receiving surface of the photovoltaic module is capable of tracking the orientation of the sun in real time during the day, allowing the light-receiving surface of the photovoltaic module to receive the maximum amount of solar radiation, thereby increasing the power generated.

Under usual circumstances, the structure of the flat single-axis tracking support is in the form of a plurality of columns supporting a main beam throughout, a photovoltaic module is mounted above the main beam, and rotates around the main beam, with the center thereof as the axis. When the main beam of such structures is relatively long, a plurality of drive devices needs to be disposed to slow the torsional oscillation of the main beam under the action of strong winds to achieve smooth driving. However, since the plurality of drive devices act on one main beam, each drive device must be rotated synchronously, which causes distortion damage to the main beam in case of any deviation. To this end, synchronous linkage is typically achieved by means of a mechanical drive rod. Although effective, this linkage method has a long drive rod, involves a large surface, is inconvenient to manufacture and mount, has a large maintenance workload and is relatively high cost.

### SUMMARY OF THE INVENTION

A brief overview of one or more aspects is provided below to provide a basic understanding of these aspects. This overview is not an exhaustive overview of all aspects conceived and is neither intended to identify the critical or decisive elements of all aspects nor to attempt to define the scope of any or all aspects. The sole purpose is to provide some concepts of one or more aspects in a simplified form as a prelude for more detailed descriptions to be provided later.

An object of the present disclosure comprises providing a photovoltaic tracking support that is capable of achieving linkage control of a plurality of drive devices and reducing maintenance workload, while reducing costs.

A further object of the present disclosure comprises providing a self-correcting linkage control method that is capable of achieving linkage control of a plurality of drive devices and reducing maintenance workload, while reducing costs.

A further object of the present disclosure comprises providing a readable storage medium that is capable of achieving linkage control of a plurality of drive devices and reducing maintenance workload, while reducing costs.

Embodiments of the present disclosure may be implemented in the following ways:

A photovoltaic tracking support for supporting a photovoltaic module, the photovoltaic tracking support comprising a main beam, a plurality of columns, and a plurality of drive devices, the plurality of columns being distributed at intervals along the length direction of the main beam, and the upper ends of the plurality of columns being rotationally connected to the main beam; the plurality of drive devices being disposed at intervals along the length direction of the main beam, the main beam being used to mount the photovoltaic module and drive the motion of the photovoltaic module under the drive of the plurality of drive devices to change the orientation of the photovoltaic module, and the photovoltaic tracking support further comprises
a plurality of angle sensors for detecting the angle at different length positions of the main beam; and
a self-correcting device comprising a controller and a plurality of position detectors, the plurality of position detectors being disposed to correspond to the plurality of drive devices one by one; the plurality of angle sensors, the plurality of position detectors, and the plurality of drive devices being electrically connected to the controller, the plurality of position detectors being used to transmit to the controller rotational position signals characterizing different length positions of the main beam; and the controller being used to control the plurality of drive devices according to the signals of the plurality of angle sensors and the plurality of position detectors.

Optionally, the position detectors comprise a turntable and a photoelectric sensor, with sensing zones being disposed at different angle positions on the turntable; one of the turntable and the photoelectric sensor being mounted on the main beam, the other of the turntable and the photoelectric sensor being mounted on the column; the photoelectric sensor being electrically connected to the controller and transmitting a sensing signal to the controller if a sensing zone is detected.

Optionally, a plurality of the sensing zones are arranged in an arc on the turntable; the sensing zones being slits or round holes disposed on the turntable.

Optionally, the plurality of angle sensors are disposed to correspond to the plurality of drive devices one by one, the angle sensors being used to detect the angle of the drive device to obtain the angle of the main beam.

A self-correcting linkage control method for the photovoltaic tracking support described above, the self-correcting linkage control method comprising obtaining the target tilt angle of the main beam;
controlling the operation of the drive device to drive the rotation of the main beam;
obtaining the rotational position signal at different length positions of the main beam during the rotation of the main beam;
if the number of the rotational position signals is smaller than the number of the position detectors, controlling the drive device corresponding to the rotational position signal position to pause until the number of the rotational position signals is equivalent to the number of the position detectors;
determining whether the main beam reaches the target tilt angle; if the main beam does not reach the target tilt angle, controlling the operation of the drive device until the main beam reaches the target tilt angle.

Optionally, after the step of determining whether the number of rotational position signals is equivalent to the number of position detectors, the self-correcting linkage control method further comprises obtaining the angle signal at different length positions of the main beam;
obtaining the angular difference at different length positions of the main beam from a plurality of the angle signals;
if the angular difference is within the preset range, determining whether the main beam reaches the target tilt angle;
if the angular difference exceeds the preset range, controlling the photovoltaic tracking support to stop operating and triggering a fault alarm.

Optionally, after the step of obtaining the target tilt angle of the main beam, the self-correcting linkage control method further comprises obtaining the angle signals of the main beam;
determining the direction of rotation of the drive device according to the target tilt angle and the angle signals.

Optionally, prior to the step of obtaining the target tilt angle of the main beam, the self-correcting linkage control method further comprises a calibration step for calibrating the angle sensor; the calibration step comprises
controlling the rotation of the main beam to a corrected position according to the rotational position signal; wherein the corrected position comprises a horizontal position, a maximum tilt angle position in a first direction and a maximum tilt angle position in a second direction;
calibrating the angle sensor.

Optionally, the self-correcting linkage control method further comprises
obtaining a calibration instruction; performing the calibration step upon receiving the calibration instruction.

A readable storage medium, with a computer program stored thereon, and the computer program is executed by a processor to implement the self-correcting linkage control method described above.

Benefits of the photovoltaic tracking support, self-correcting linkage control method, and readable storage medium provided by the examples of the present disclosure include
a photovoltaic tracking support provided by the examples of the present disclosure for supporting a photovoltaic module. The photovoltaic tracking support comprises a main beam, a plurality of columns, and a plurality of drive devices. The plurality of columns are distributed at intervals along the length direction of the main beam, and the upper ends of the plurality of columns are rotationally connected to the main beam. A plurality of drive devices are disposed at intervals along the length direction of the main beam to drive the main beam to rotate relative to the column. The main beam is used to mount the photovoltaic module, while driving the motion of the photovoltaic module during the rotation of the main beam, thereby changing the orientation of the photovoltaic module, allowing the light-receiving surface of the photovoltaic module to receive the maximum amount of solar radiation. At the same time, the photovoltaic tracking support further comprises a self-correcting device and a plurality of angle sensors for detecting the angle at different length positions of the main beam, the self-correcting device comprising a controller and a plurality of position detectors, the plurality of position detectors being disposed to correspond to the plurality of drive devices one by one. The plurality of angle sensors, the plurality of position detectors, and the plurality of drive devices are all electrically connected to the controller, the plurality of position detectors being used to transmit to the controller rotational position signals characterizing different length positions of the main beam, while the controller controls the drive devices according to the signals of the plurality of angle sensors and the plurality of position detectors, thereby achieving linkage control of the plurality of drive devices. The photovoltaic tracking support uses mechanical and electrical structures for linkage control of the plurality of drive devices, has a simple structure, a small maintenance workload, and helps to reduce costs.

The examples of the present disclosure further provide a self-correcting linkage control method for the photovoltaic tracking support described above. The self-correcting linkage control method comprises obtaining the target tilt angle of the main beam; controlling the operation of the drive device to drive the rotation of the main beam; obtaining the rotational position signal at different length positions of the main beam during the rotation of the main beam; if the number of the rotational position signals is smaller than the number of the position detectors, controlling the drive device corresponding to the rotational position signal position to pause until the number of the rotational position signals is equivalent to the number of the position detectors; determining whether the main beam reaches the target tilt angle and if the main beam does not reach the target tilt angle, controlling the operation of the drive device until the main beam reaches the target tile angle. This self-correcting linkage control method achieves linkage control of the plurality of drive devices, effectively avoiding the problems caused by the use of drive rod linkage, has a small maintenance workload, and helps to reduce costs.

The examples of the present disclosure further provide a readable storage medium for implementing the self-correcting linkage control method described above, and thus also has the benefits of effectively avoiding the problems caused by the use of drive rod linkage, having a small maintenance workload, and helping to reduce costs.

### DESCRIPTION OF ACCOMPANYING DRAWINGS

After reading the detailed description of the examples of the present disclosure in conjunction with the following accompanying drawings, the above features and advantages of the present disclosure can be better understood. In the accompanying drawings, components are not necessarily to scale, and components having similar related characteristics or features may have the same or similar reference marks.

FIG. 1 shows a partial structural schematic diagram of the photovoltaic tracking support provided according to an aspect of the present disclosure;

FIG. 2 shows a structural schematic diagram of a position detector in a photovoltaic tracking support provided according to an aspect of the present disclosure;

FIG. 3 shows a structural block diagram of a control portion in a photovoltaic tracking support provided according to an aspect of the present disclosure;

FIG. 4 shows a schematic diagram of a turntable in a photovoltaic tracking support according to an aspect of the present disclosure;

FIG. 5 shows a schematic diagram of a turntable in a photovoltaic tracking support according to another aspect of the present disclosure;

FIG. 6 shows a control flow chart of a self-correcting linkage control method in the automatic mode provided according to an aspect of the present disclosure;

FIG. 7 shows a control flow chart for performing the calibration mode in a self-correcting linkage control method provided according to an aspect of the present disclosure.

### REFERENCE MARKS

100—photovoltaic tracking support; 111—main beam; 112—column; 113—drive device; 114—angle sensor; 115—self—correcting device; 116—turntable; 117—sensing zone; 118—photoelectric sensor; 119—controller.

### Specific Embodiments

The present disclosure is described in detail below with reference to the accompanying drawings and specific examples. Note that the aspects described below in conjunction with the accompanying drawings and specific examples are exemplary only in all aspects and should not be construed as limiting the scope of protection of the present disclosure.

In the description of the present disclosure, it should be noted that if the orientation or positional relationship is indicated by the terms “upper”, “lower”, “inner”, “outer”, “vertical”, and the like, it is based on the orientation or positional relationship shown in the accompanying drawings, or the customary orientation or positional relationship during the use of the inventive product, rather than indicating or implying that the device or element indicated must have a specific orientation or be constructed and operated in a specific orientation, so it cannot be understood as a limitation of the present disclosure.

At the same time, it should be noted that the terms “first,” “second,” and the like are used only to make a distinct description and are not to be construed as indicating or implying relative importance.

In the description of the present disclosure, it should be noted that unless otherwise expressly specified or limited, the terms “mounted”, “attached”, and “connected” should be understood in a broad sense, for example, they may be fixedly connected, they may be integrally connected or detachably connected; they may be mechanically connected, they may be electrically connected; they may be directly connected, they may be indirectly connected through an intermediary medium, they may be connected inside two elements, or the like. The specific meaning of the above terms in the present disclosure may be understood by those skilled in the art based on the specific situation.

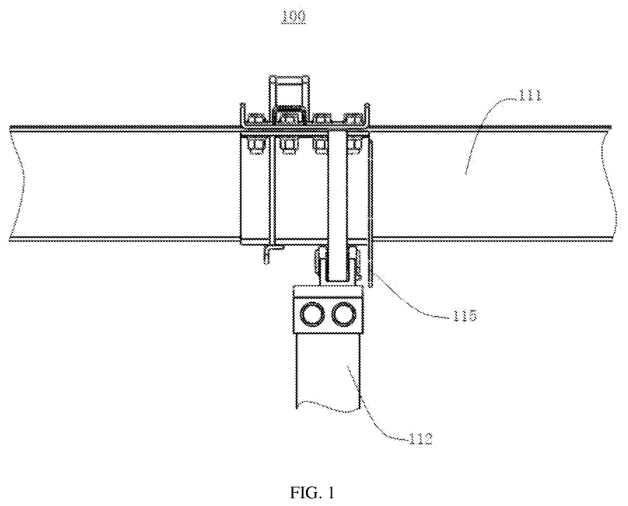

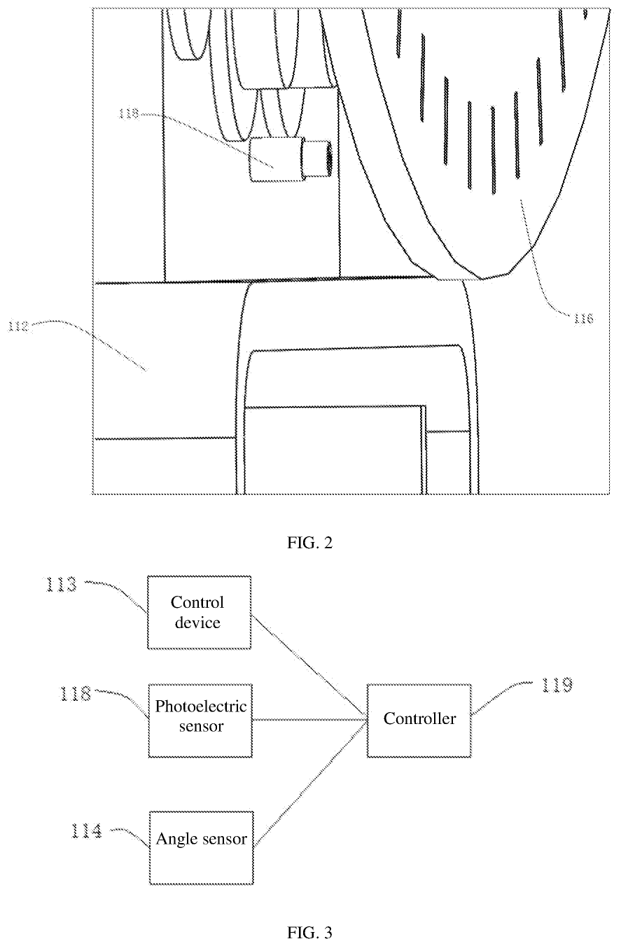

FIG. 1 shows a partial structural schematic diagram of a photovoltaic tracking support 100 provided by the present example, FIG. 2 shows a structural schematic diagram of a position detector in the photovoltaic tracking support 100 provided by the present example, and FIG. 3 shows a structural block diagram of a control portion in the photovoltaic tracking support 100 provided by the present example. With reference to FIG. 1-FIG. 3, the present example provides the photovoltaic tracking support 100.

The photovoltaic tracking support 100 comprises a main beam 111, a plurality of columns 112, and a plurality of drive devices 113. The main beam 111 is used to mount a photovoltaic module, the plurality of columns 112 are distributed at intervals along the length direction of the main beam 111, and the upper ends of the plurality of columns 112 are all rotationally connected to the main beam 111, thereby supporting the same main beam 111 through the rotation of the plurality of columns 112, i.e., the photovoltaic tracking support 100 is a flat single-axis tracking support. The plurality of drive devices 113 are disposed at intervals along the length direction of the main beam 111, and the main beam 111 is driven to rotate through the common action of the plurality of drive devices 113, thereby driving the rotation of the photovoltaic module and changing the orientation of the photovoltaic module, allowing the light-receiving surface of the photovoltaic module to receive the maximum amount of solar radiation, so as to increase the power generated by the photovoltaic module.

The photovoltaic tracking support 100 further comprises a self-correcting device 115 and a plurality of angle sensors 114 for detecting the angle at different length positions of the main beam 111. In the present example, the angle sensors 114 are disposed to correspond to the drive devices 113 one by one, and the angle sensors 114 are disposed at the motor of the drive devices 113 to obtain the rotation angle of the main beam 111 where the drive devices 113 are mounted by detecting the motor rotation angle. It should be understood that in other examples, the rotation angle of the main beam 111 may also be obtained by other means. The self-correcting device 115 comprises a controller 119 and a plurality of position detectors, the plurality of position detectors being disposed to correspond to the plurality of drive devices 113 one by one. At the same time, the plurality of angle sensors 114, the plurality of position detectors, and the plurality of drive devices 113 are all electrically connected to the controller 119, the plurality of position detectors being used to transmit to the controller 119 rotational position signals characterizing different length positions of the main beam 111, while the controller 119 controls the plurality of drive devices 113 according to the signals of the plurality of angle sensors 114 and the plurality of position detectors, thereby achieving linkage control of the plurality of drive devices 113. It should be noted that in the description of the present example, “position detectors correspond to the drive devices 113” refers to the position of the position detectors in the length direction of the main beam 111 being basically consistent with the position of the drive devices 113 in the length direction of the main beam 111.

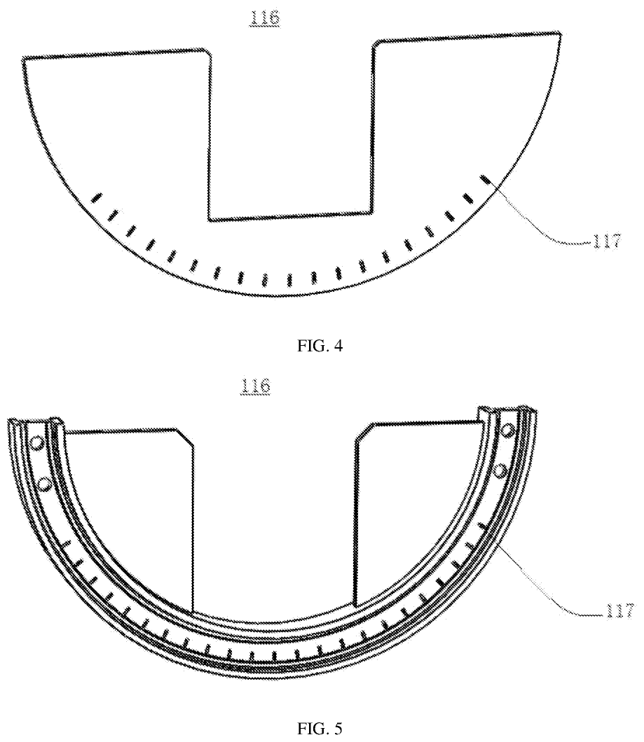

FIG. 4 shows a schematic diagram of a turntable 116 in the photovoltaic tracking support 100 provided by the present example. With reference to FIG. 1-FIG. 4, the position detector comprises a turntable 116 and a photoelectric sensor 118, with one of the turntable 116 and the photoelectric sensor 118 being mounted on the main beam 111 and the other of the turntable 116 and the photoelectric sensor 118 being mounted on the column 112. Sensing zones 117 are disposed at different angle positions on the turntable 116. During the rotation of the main beam 111 relative to the column 112, the turntable 116 rotates relative to the photoelectric sensor 118. After the photoelectric sensor 118 senses a sensing zone 117 of the turntable 116, it sends a rotational position signal to the controller 119. In the present example, the turntable 116 is mounted on the main beam 111 and the photoelectric sensor 118 is mounted on the column 112.

Optionally, the turntable 116 is a fan-shaped thin plate. Several slits are arranged in an arc at the portion of the plate near the outer periphery. Such slits serve as the sensing zones 117. It should be understood that in other examples, round holes may also be disposed as the sensing zones 117. On the other hand, the turntable 116 may also be disposed as an arcuate structure. In the structure shown in FIG. 5, the sensing zones 117 are disposed on an arcuate bearing of the main beam 111 to serve as the turntable 116.

In particular, the photoelectric sensor 118 may use a reflective sensing element, where the photoelectric sensor 118 emits light to the turntable 116 and receives light reflected from the turntable 116, and when the photoelectric sensor 118 corresponds to the position of the sensing zone 117 of the turntable 116, the light emitted by the photoelectric sensor 118 passes through a slit that serves as the sensing zone 117, at which point the photoelectric sensor 118 is unable to receive the reflected light, thereby transmitting a rotational position signal to the controller 119.

It should be understood that in other examples, the photoelectric sensor 118 may also be disposed as a structure containing two portions, namely a transmitting end and a receiving end. At this point, the transmitting end and the receiving end are respectively disposed at both ends of the turntable 116. When the turntable 116 rotates to the corresponding optical path position of the sensing zone 117 between the transmitting end and the receiving end, the light emitted from the transmitting end passes through the slit that serves as the sensing zone 117 and is received by the receiving end, and the photoelectric sensor 118 sends a rotational position signal to the controller 119. The controller 119 performs linkage control of the plurality of drive devices 113 according to the detected signal of the angle sensor 114 and the photoelectric sensor 118. Accordingly, the present example further provides a self-correcting linkage control method, and the controller 119 performs the self-correcting linkage control method to achieve linkage control of the plurality of drive devices 113.

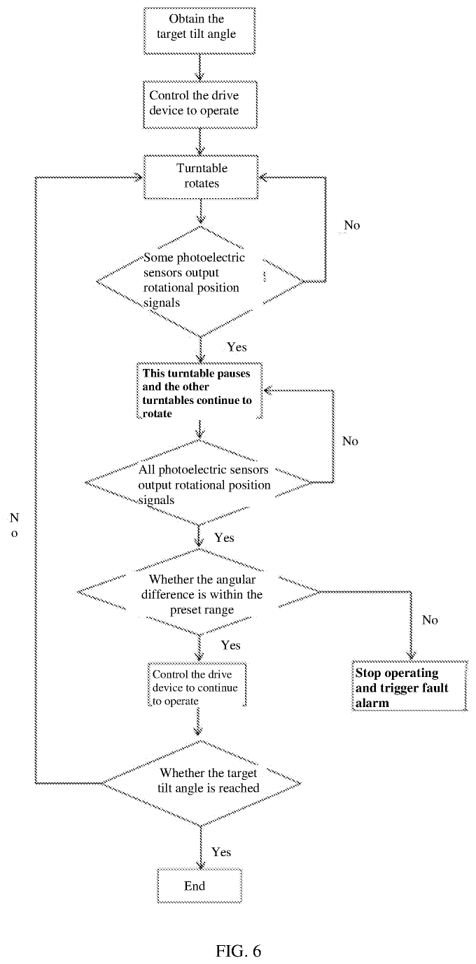

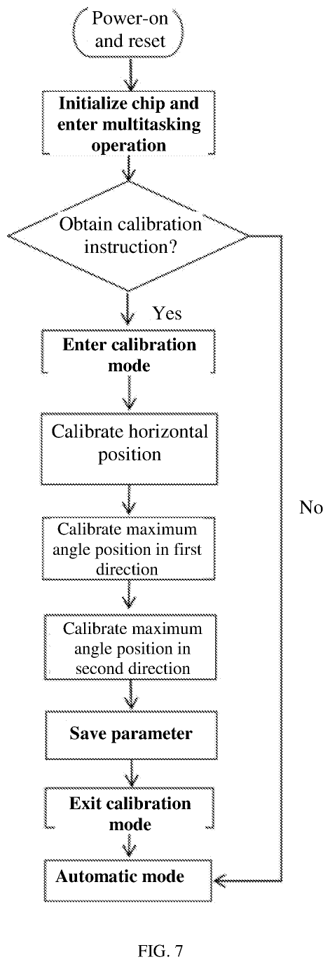

FIG. 6 shows a control flow chart of the self-correcting linkage control method in the automatic mode provided in the present example, and FIG. 7 shows a control flow chart for performing the calibration mode in the self-correcting linkage control method provided in the present example. With reference to FIGS. 6 and 7, in the present example, the self-correcting linkage control method comprises:

S01: obtaining the target tilt angle of the main beam 111.

The target tilt angle of the main beam 111 is obtained by calculation based on an active tracking algorithm, which may be an orientation of the sun in the sky calculated based on an astronomical algorithm and converted to a desired tilt angle position of the current photovoltaic module.

S02: controlling the operation of the drive device 113 to drive the rotation of the main beam 111.

Control signals are sent to the plurality of drive devices 113, and the plurality of drive devices 113 are controlled to start operation, thereby driving the rotation of the photovoltaic module to the target tilt angle through the rotation of the main beam 111.

Further, prior to controlling the operation of the drive device 113, the self-correcting linkage control method further comprises
obtaining the angle signals of the main beam 111; determining the direction of rotation of the drive device 113 based on the target tilt angle and angle signals.

The plurality of angle sensors 114 transmits the detected angle signals of the main beam 111 to the controller 119, which compares the angle signals with the target tilt angle to determine whether the actual angle of the main beam 111 (i.e., the angle detected by the angle sensor 114) at this point leads or lags the target tilt angle. If the actual angle of the main beam 111 is smaller than the target tilt angle, the main beam 111 lags the target tilt angle, and the controller 119 controls the plurality of the drive devices 113 such that the main beam 111 rotates in a forward direction to the target tile angle. If the actual angle of the main beam 111 is greater than the target tilt angle, the main beam 111 leads the target tilt angle, and the controller 119 controls the plurality of drive devices 113 to rotate in a reverse direction such that the main beam 111 rotates to the target tilt angle. If the actual angle of the main beam 111 is equivalent to the target tilt angle, there is no need to control the rotation of the main beam 111.

S03: obtaining the rotational position signal at different length positions of the main beam 111 during the rotation of the main beam 111.

The rotational position signal output by the plurality of position detectors is obtained in real time during the rotation of the main beam 111. When the photoelectric sensor 118 senses a sensing zone 117 of the turntable 116, it transmits the rotational position signal to the controller 119. If the controller 119 only receives a portion of the rotational position signals sent by the photoelectric sensor 118, i.e., the number of transmission position signals obtained by the controller 119 is lower than the number of position detectors, the drive device 113 corresponding to the position detector is controlled to pause until the number of rotational position signals obtained by the controller 119 is consistent with the number of position detectors, i.e., at this point all the photoelectric sensors 118 sense the sensing zone 117 of the turntable 116.

S04: determining whether the main beam 111 reaches the target tilt angle, if the main beam 111 does not reach the target tilt angle, controlling the drive device 113 to operate until the main beam 111 reaches the target tilt angle.

The angle signals transmitted by the plurality of angle sensors 114 are obtained and whether the main beam 111 reaches the target tilt angle is determined based on the angle signal. If the main beam 111 does not reach the target tilt angle, perform step S02 and step S03 again until the main beam 111 reaches the target tilt angle.

Further, before performing step S04, in order to ensure that all the angle positions along the length direction of the main beam 111 are consistent and to avoid torsion of the main beam 111, the self-correcting linkage control method further comprises

S51: obtaining the angle signal at different length positions of the main beam 111.

The angle signals detected by the plurality of angle sensors 114 are obtained.

S52: obtaining the angular difference at different length positions of the main beam 111 from a plurality of angle signals;

The angle values at the corresponding positions of the main beam 111 are obtained from the angle signals detected by the plurality of angle sensors 114, and any two of the plurality of angle values are subtracted from each other, thereby obtaining the angular difference at two length positions of the main beam 111.

S53: if the angular difference is within the preset range, determining whether the main beam 111 reaches the target tilt angle;

Perform the calculation in step S52 to obtain a plurality of angular differences and if the plurality of angular differences is within the preset range, perform step S04. The preset range is a range value preset according to the requirements. In the present example, the preset range is less than or equal to 2°.

S54: if the angular difference is not within the preset range, controlling the photovoltaic tracking support 100 to stop operating and triggering a fault alarm.

If any of the plurality of angular differences calculated in step S52 exceeds the preset range, and there is torsion of the main beam 111 at this point, the photovoltaic tracking support 100 is controlled to stop operating and a fault alarm is triggered. Specifically, the fault alarm may be triggered by using warning lights, sounding an alarm, or the like. If any of the plurality angular differences is greater than 2°, the angular difference is not within the preset range.

As shown in FIG. 7, before the photovoltaic tracking support 100 achieves the automatic tracking of the orientation of the sun in the automatic mode, the self-correcting linkage control method further comprises

S06: a calibration step.

When the photovoltaic tracking support 100 is activated and the controller 119 is powered on and reset, the controller first initializes the chip and enters multitasking operation. The angle sensor 114 is then calibrated to ensure that the angle of the angle sensor 114 is consistent with the position of the main beam 111 and the position of the position detector. The calibration step comprises

S61: controlling the rotation of the main beam 111 to a corrected position according to the rotational position signal.

The corrected position comprises a maximum tilt angle position in a first direction and a maximum tilt angle position in a second direction, the maximum tilt angle position in the first direction and the maximum tilt angle position in the second direction being located at both ends of the horizontal position, respectively, and the maximum tilt angle position in the first direction and the maximum tilt angle position in the second direction are two extreme positions of the rotation trajectory of the main beam 111.

S62: calibrating the angle sensor 114.

When performing the calibration step, the plurality of drive devices 113 are controlled synchronously. Specifically, the main beam 111 may first be controlled to be in the horizontal position. At this point, the output value of the angle sensor 114 is defined as 0°, then the main beam 111 is controlled to rotate to the maximum angle position on both sides, and the output value of the angle sensor 114 is defined. After the error data is saved, it enters the automatic operation mode. The maximum angle position on both sides is the maximum tilt angle position in the first direction and the maximum tilt angle position in the second direction, which are the maximum target tilt angle positions that the main beam 111 is required to rotate to as calculated based on the tilt angle of the sun. Accordingly, sensing zones 117 corresponding to the horizontal position, the maximum tilt angle position in the first direction, and the maximum tilt angle position in the second direction may be disposed on the turntable 116, respectively, and after the calibration, the controller 119 may calculate the angle corresponding to the rotational position detected by the position detectors based on the number of rotational position signals transmitted by the position detectors and verify the rotational position signals transmitted by the position detectors against the angle signals transmitted the angle sensor 114 to ensure control accuracy.

Prior to the calibration step, the self-correcting linkage control method further comprises obtaining the calibration instruction; performing step S06 upon receiving the calibration instruction.

In the present example, a calibration button is disposed on the photovoltaic tracking support 100, and the operator presses the calibration button to send a calibration instruction to the controller 119. At this point, the photovoltaic tracking support 100 enters the calibration mode, thereby performing step S06. After the calibration is completed, the photovoltaic tracking support 100 exits the calibration mode, and the photovoltaic tracking support 100 enters the automatic mode. It should be understood that in other examples, it may also be set to automatically enter the calibration mode after the controller 119 is powered on and reset, without having to obtain a calibration instruction.

The examples of the present disclosure further provide a readable storage medium, with a computer-readable computer program stored thereon, and the computer program is executed by a processor to implement one or more steps in the self-correcting linkage control method. In particular, the readable storage medium may be any available medium that a computer is capable of storing or a data storage device including one or more servers, data centers, and the like that may be integrated by a medium.

The examples above are only specific embodiments of the present disclosure but the scope of protection of the present disclosure is not limited thereto. Any changes or replacements that can be easily thought of by those skilled in the art within the scope of the technology disclosed by the present disclosure should be covered by the scope of protection of the present disclosure.

1-10. (canceled)

11. A photovoltaic tracking support for supporting a photovoltaic module, the photovoltaic tracking support comprising:
a main beam, a plurality of columns, and a plurality of drive devices;
wherein the plurality of drive devices are disposed at intervals along the length direction of the main beam, the plurality of columns configured to support the main beam, the main beam configured to mount a photovoltaic module and the plurality of drive devices operable to change the orientation of the photovoltaic module;
a plurality of angle sensors for detecting the angle at different length positions of the main beam; and
a self-correcting device comprising a controller and a plurality of position detectors;
wherein the plurality of angle sensors, the plurality of position detectors, and the plurality of drive devices are electrically connected to the controller,
the plurality of position detectors configured to transmit to the controller rotational position signals characterizing different length positions of the main beam; and
the controller configured to control the plurality of drive devices according to the signals of the plurality of angle sensors and the plurality of position detectors.

12. The photovoltaic tracking support according to claim 11, wherein the plurality of columns are distributed at regular intervals along the length direction of the main beam.

13. The photovoltaic tracking support according to claim 11, wherein the plurality of columns comprise a plurality of upper ends rotationally connected to the main beam.

14. The photovoltaic tracking support according to claim 11, wherein the position detectors comprise a turntable and a photoelectric sensor, with sensing zones being disposed at different angle positions on the turntable; one of the turntable and the photoelectric sensor being mounted on the main beam, the other of the turntable and the photoelectric sensor being mounted on the column; the photoelectric sensor being electrically connected to the controller and transmitting a sensing signal to the controller if a sensing zone is detected.

15. The photovoltaic tracking support according to claim 14, wherein photoelectric sensor is electrically connected to the controller and configured to transmit a sensing signal to the controller if a sensing zone is detected.

16. The photovoltaic tracking support according to claim 15, wherein a plurality of the sensing zones are arranged in an arc on the turntable.

17. The photovoltaic tracking support according to claim 16, wherein the sensing zones comprise slits or round holes disposed on the turntable.

18. The photovoltaic tracking support according to claim 11, wherein the plurality of angle sensors are disposed to correspond to the plurality of drive devices one by one.

19. The photovoltaic tracking support according to claim 18, wherein the angle sensors are configured to detect the angle of the drive device to obtain the angle of the main beam.

20. A self-correcting linkage control method comprising:
providing a photovoltaic tracking support comprising a main beam, a plurality of columns, and a plurality of drive devices, wherein the plurality of drive devices are disposed at intervals along the length direction of the main beam, the plurality of columns are configured to support the main beam, the main beam configured to mount a photovoltaic module;
obtaining a target tilt angle of the main beam;
controlling the operation of one of the plurality of drive devices to drive the rotation of the main beam;
obtaining the rotational position signal at different length positions of the main beam during the rotation of the main beam.

21. The self-correcting linkage control method according to claim 20, wherein, if the number of the rotational position signals is smaller than the number of the position detectors, controlling the drive device corresponding to the rotational position signal position to pause until the number of the rotational position signals is equivalent to the number of the position detector.

22. The self-correcting linkage control method according to claim 20, further comprising determining whether the main beam reaches the target tilt angle; if the main beam does not reach the target tilt angle, controlling the operation of the drive device until the main beam reaches the target tilt angle.

23. The self-correcting linkage control method according to claim 20, characterized in that after the step of determining whether the number of rotational position signals is equivalent to the number of position detectors, the self-correcting linkage control method further comprises:
obtaining the angle signal at different length positions of the main beam;
obtaining the angular difference at different length positions of the main beam from a plurality of the angle signals;
if the angular difference is within the preset range, determining whether the main beam reaches the target tilt angle; and
if the angular difference exceeds the preset range, controlling the photovoltaic tracking support to stop operating and triggering a fault alarm.

24. The self-correcting linkage control method according to claim 20, characterized in that after the step of obtaining the target tilt angle of the main beam, the self-correcting linkage control method further comprises:
obtaining the angle signals of the main beam; and
determining the direction of rotation of the drive device according to the target tilt angle and the angle signals.

25. The self-correcting linkage control method according to claim 20, characterized in that prior to the step of obtaining the target tilt angle of the main beam, the self-correcting linkage control method further comprises a calibration step for calibrating the angle sensor; the calibration step comprises
controlling the rotation of the main beam to a corrected position according to the rotational position signal;
wherein the corrected position comprises a horizontal position, a maximum tilt angle position in a first direction and a maximum tilt angle position in a second direction; and
calibrating the angle sensor.

26. The self-correcting linkage control method according to claim 25, characterized in that the self-correcting linkage control method further comprises
obtaining a calibration instruction; performing the calibration step upon receiving the calibration instruction.

27. A computer readable storage medium, characterized in that a computer program is stored thereon, and the computer program is executed by a processor to implement the self-correcting linkage control method according to claim 20.
